(19) United States
(12) Patent Application Publication
(10) Pub. No.: US 2026/0049921 A1
(43) Pub. Date: Feb. 19, 2026

(54) APPARATUS FOR DETECTING SUSPENDED ORGANIC MATTER

(71) Applicant: SEOUL VIOSYS CO., LTD., Ansan-si (KR)

(72) Inventor: Jaehak JEONG, Ansan-si (KR)

(73) Assignee: SEOUL VIOSYS CO., LTD., Ansan-si (KR)

(21) Appl. No.: 19/284,873

(22) Filed: Jul. 30, 2025

Related U.S. Application Data
(60) Provisional application No. 63/682,710, filed on Aug. 13, 2024.

(51) Int. Cl. G01N 15/075

(52) U.S. Cl. CPC G01N 15/075

(57) ABSTRACT

A suspended organic matter detection apparatus, more particularly, a suspended organic matter detection apparatus capable of detecting suspended organic matter in a fluid by sensing excitation light from the suspended organic matter in the fluid is provided. The suspended organic matter detection apparatus includes: a chamber defining a flow path of the fluid and including a light irradiation region on an inner wall thereof; a light source configured to deliver light to the light irradiation region; and a light sensor configured to detect light within the chamber, wherein the chamber includes an opening for introducing or discharging the fluid into or from an internal space of the chamber.

### CROSS-REFERENCE OF RELATED APPLICATIONS

The present application claims the benefit of priority to U.S. Provisional Application No. 63/682,710, filed Aug. 13, 2024, the disclosure of which is incorporated by reference herein in its entirety.

### TECHNICAL FIELD

Embodiments of the present disclosure relate to a suspended organic matter detection apparatus and, more particularly, to a suspended organic matter detection apparatus capable of detecting suspended organic matter in a fluid by sensing excitation light from the suspended organic matter in the fluid.

### BACKGROUND

Indoor or outdoor air contains fine organic matter, such as bacteria, mold, and viruses. Exposure to air with high concentrations of such fine organic matter can lead to illnesses, such as headaches, dizziness, or allergies. Therefore, there is a need for technology that can detect such microbial contamination in the air and manage the contamination level thereof.

When fine organic matter contained in the air is irradiated with light of a specific wavelength, the fine organic matter absorbs the light and emits excitation light. By sensing this excitation light, the presence of fine organic matter in the air and its contamination level can be detected.

However, there is a problem in that light incident on fine organic matter acts as noise and excitation light from the fine organic matter is weak, which can reduce accuracy in detection of the excitation light and can cause measurement errors.

### SUMMARY

It is an aspect of the present disclosure to provide a suspended organic matter detection apparatus capable of accurately detecting the presence or quantity of suspended organic matter in a fluid.

In accordance with one aspect of the present disclosure, there is provided a suspended organic matter detection apparatus, including a chamber configured to define a flow path of a fluid and including a light irradiation region on an inner wall thereof; a light source including a first semiconductor layer, a second semiconductor layer and an active layer disposed between the first semiconductor layer and the second semiconductor layer, and configured to deliver light to the light irradiation region; and a light sensor configured to detect light within the chamber, wherein the chamber comprises an opening for introducing or discharging the fluid into or from an internal space of the chamber, and wherein the light sensor is configured to detect suspended organic matter in the fluid entering the internal space of the chamber.

In one embodiment, an optical axis of the light emitted from the light source may be tilted at an acute angle with respect to the inner wall of the chamber on which the light irradiation region is formed.

In one embodiment, the optical axis may be tilted at an angle of 10° to 20° with respect to the inner wall of the chamber on which the light irradiation region is formed.

In one embodiment, the light emitted from the light source may have a peak wavelength of 350 nm to 400 nm.

In one embodiment, the light sensor may detect excitation light from the suspended organic matter.

In one embodiment, the light source may have a beam angle of 60° or less.

In one embodiment, the light sensor may be disposed adjacent to the opening.

In one embodiment, the light source may include a light emitting device and a base supporting the light emitting device.

In one embodiment, the light source may further include a lens disposed above the light emitting device.

In one embodiment, the light source may further include a substrate forming a concave cavity in which the light emitting device is seated.

In one embodiment, a side surface of the cavity may be an inclined reflective surface.

In one embodiment, the light source may further include a reflective sidewall surrounding a side surface of the lens and reflecting light transmitted through the lens.

In one embodiment, the light source may further include at least one optical member configured to concentrate light transmitted through the lens.

In one embodiment, the light source may further include an optical filter disposed above the lens to transmit light of a specific wavelength therethrough.

In one embodiment, the internal space of the chamber may be partitioned into a first internal space and a second internal space by the base.

In one embodiment, the base may be formed with a passage to allow communication between the first internal space and the second internal space.

In one embodiment, the light source may be disposed on one surface of the base facing the second internal space.

In one embodiment, the opening may communicate with the first internal space.

In one embodiment, the chamber may further include a reflective layer coated on the inner wall thereof.

In one embodiment, the light sensor may be disposed at the first internal space side to detect reflected light directed from the second internal space to the first internal space.

In one embodiment, the suspended organic matter detection apparatus may further include an optical filter configured to partially reflect light within the chamber while partially transmitting the light.

In one embodiment, the light sensor may include a first optical sensor configured to detect light reflected from the optical filter and a second optical sensor configured to detect light transmitted through the optical filter.

In one embodiment, an emission pattern of light emitted from the light source unit may have a first peak and a second peak.

In accordance with another aspect of the present disclosure, there is provided a suspended organic matter detection apparatus, including: a chamber configured to define a flow path of a fluid and including a light irradiation region on an inner wall thereof; a light source including a first semiconductor layer, a second semiconductor layer and an active layer disposed between the first semiconductor layer, and the second semiconductor layer, and configured to deliver light to the light irradiation region; and a light sensor configured to detect light within the chamber, wherein the light source has a beam angle of 60° or less, and wherein the light sensor is configured to detect suspended organic matter in the fluid entering the internal space of the chamber.

In accordance with a further aspect of the present disclosure, there is provided a suspended organic matter detection apparatus, including: a chamber configured to define a flow path of a fluid and including a light irradiation region on an inner wall thereof; a light source unit including a first semiconductor layer, a second semiconductor layer, and an active layer disposed between the first semiconductor layer and the second semiconductor layer, and configured to deliver light to the light irradiation region; and a light sensor configured to detect light within the chamber, wherein a difference in peak wavelength between light emitted from the light source and light detected by the light sensor unit is 50 nm or more, and wherein the light sensor is configured to detect suspended organic matter in the fluid entering the internal space of the chamber.

Embodiments of the present disclosure may provide a suspended organic matter detection apparatus capable of detecting the presence or quantity of suspended organic matter in a fluid under analysis.

Embodiments of the present disclosure may provide a suspended organic matter detection apparatus that can ensure sufficient residence time of a fluid under analysis within a chamber receiving the fluid through structural optimization of an internal space of the chamber, thereby allowing reliable detection of suspended organic matter in the fluid and enhanced measurement accuracy.

Embodiments of the present disclosure may provide a suspended organic matter detection apparatus that can improve light output through improvement in luminous intensity of a light source unit, thereby enabling accurate capture of faint optical signals resulting from suspended organic matter.

Embodiments of the present disclosure may provide a suspended organic matter detection apparatus that can ensure concentration of light from the light source onto a light irradiation region, thereby improving light collection efficiency and allowing effective detection of reflected or scattered light signals from the light irradiation region.

Embodiments of the present disclosure may provide a suspended organic matter detection apparatus that utilizes a light source configured to emit light in a wavelength range optimized for measuring microorganisms or bio-particles, thereby ensuring enhanced power efficiency and optical efficiency, as compared to typical methods.

Embodiments of the present disclosure may provide a suspended organic matter detection apparatus that can minimize noise in a light sensor by preventing light emitted from the light source from being directly delivered to the light sensor.

Embodiments of the present disclosure may provide a suspended organic matter detection apparatus that has improved reliability by allowing excitation light or scattered light from particles contained in a fluid under analysis to be incident on the light sensor.

### BRIEF DESCRIPTION OF THE DRAWINGS

FIG. 1 is a schematic view of a suspended organic matter detection apparatus according to one embodiment of the present disclosure.

FIG. 2 is a schematic view of a suspended organic matter detection apparatus according to another embodiment of the present disclosure.

FIG. 3 is a schematic view of a suspended organic matter detection apparatus according to a further embodiment of the present disclosure.

FIG. 4 is a graph depicting one example of light intensity as a function of central angle with respect to an optical axis in the light source unit of the suspended organic matter detection apparatus according to the present disclosure.

FIG. 5 is a graph depicting another example of light intensity as a function of central angle with respect to the optical axis in the light source unit of the suspended organic matter detection apparatus according to the present disclosure.

FIG. 6 is a view illustrating an emission pattern of light emitted from the light source unit within the suspended organic matter detection apparatus according to the present disclosure.

FIG. 7A to FIG. 7C are a plan view, a bottom view, and a side view of an example of the light source unit of the suspended organic matter detection apparatus according to the present disclosure, respectively.

FIG. 8 is a modification of FIG. 7C.

FIG. 9 to FIG. 13 are cross-sectional side views of another example of the light emitter of the suspended organic matter detection apparatus according to the present disclosure.

FIG. 14A and FIG. 14B are a partial top view and a partial bottom view of the suspended organic matter detection apparatus according to the present disclosure, respectively.

FIG. 15 is an enlarged cross-sectional view taken along line I-I′ of FIG. 14B.

### DETAILED DESCRIPTION OF EMBODIMENTS

In the following description, for the purposes of explanation, numerous specific details are set forth in order to provide thorough understanding of various exemplary embodiments or implementations of the present disclosure. As used herein, “embodiments” and “implementations” are interchangeable terms for non-limiting examples of devices or methods employing one or more of the inventive concepts disclosed herein. It will be apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects (hereinafter individually or collectively referred to as “elements”) of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, and property of the elements, unless specified. Further, in the accompanying drawings, the size and relative sizes of elements may be exaggerated for clarity and/or descriptive purposes. When an exemplary embodiment is implemented differently, a specific process order may be performed differently from the described order. For example, two consecutively described processes may be performed substantially at the same time or performed in an order opposite the described order. In addition, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” and the like may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (for example, as in “sidewall”), and the like, may be used herein for descriptive purposes, and, thereby, to describe one element's relationship to other element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (for example, rotated 90 degrees or at other orientations), and, as such, the spatially relative descriptors used herein may likewise interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (for example, microcode) to perform various functions discussed herein and may optionally be driven by firmware and/or software. It is also contemplated that each block, unit, and/or module may be implemented by dedicated hardware, or as a combination of dedicated hardware to perform some functions and a processor (for example, one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure pertains. Terms, such as those defined in commonly used dictionaries, should be interpreted as having a meaning that is consistent with their meaning in the context of the relevant art and should not be interpreted in an idealized or overly formal sense, unless expressly so defined herein.

The present disclosure provides a suspended organic matter detection apparatus for detecting suspended organic matter in a fluid. Herein, “suspended organic matter” may refer to pollutants contained in a fluid, for example, air, including microorganisms, bacteria, or others attached to dust or water vapor. Such suspended organic matter can adversely affect the human respiratory system and can cause pathogenic infections.

By way of example, FIG. 1 illustrates a suspended organic matter detection apparatus 100 according to one embodiment of the present disclosure.

The suspended organic matter detection apparatus 100 may include: a chamber 110 defining a flow path of a fluid and including a light irradiation region A on an inner wall IS thereof; a light source unit 120 configured to deliver light to the light irradiation region A; and a light sensor unit 130 configured to detect light within the chamber 110.

Referring to FIG. 1, the chamber 110 is enclosed by a plurality of walls 112, 114, and 116 to provide a flow path of a fluid and may be configured in various ways. For example, the chamber 110 may be formed in a hexahedral shape. However, it should be understood that the present disclosure is not limited thereto and the chamber 110 may be formed in various other shapes, such as a cylindrical shape, a columnar shape, a conical shape, a spherical shape, a cuboidal shape, a pyramidal shape, an ellipsoidal shape, a polyhedral shape, a container-like shape, or an irregular shape. That is, the shape of the chamber 110 is not particularly restricted and the chamber 110 may be formed in any shape so long as the fluid can stay or can be contained within the chamber.

In addition, the chamber 110 may include a reflective material disposed in at least one region thereof to reflect light. For example, the reflective material may be a reflective layer disposed on the inner wall IS of the chamber 110. The reflective layer may include a reflective metal, such as aluminum or silver. Further, the reflective layer may include a metal oxide, such as titanium dioxide (TiO₂). However, it should be understood that the present disclosure is not limited thereto and the reflective layer may include other oxides having high reflectivity, for example, aluminum oxide (Al₂O₃), silicon dioxide (SiO₂), zirconium oxide (ZrO₂), hafnium oxide (HfO₂), magnesium oxide (MgO), lanthanum oxide (La₂O₃), or combinations thereof. The reflective layer serves to reflect and concentrate light emitted from the light source unit 120 onto a specific target region, thereby enhancing light irradiation efficiency and thus contributing to enhancement in photoreaction or detection sensitivity.

In addition, the chamber 110 may be formed therein with a flow path of the fluid and may have a curved inner surface. The curved inner surface may be formed along the flow path of the fluid and may have different curvatures in different sections or regions of the flow path of the fluid. The curved inner surface of the chamber 110 serves to induce a vortex, thereby increasing the residence time of the fluid within the chamber and thus enhancing the accuracy of detecting suspended organic matter.

The chamber 110 may be housed within a separate external housing.

The chamber 110 may include a light irradiation region A on the inner wall IS thereof.

The light irradiation region A may correspond to a stagnation zone in which the fluid flowing within the chamber 110 is decelerated and becomes stagnant. The light irradiation region A may be defined as a region on inner surfaces of the walls 112, 114, and 116 constituting the chamber 110, which is irradiated with light. The area of the light irradiation region A may be varied, as needed.

The stagnation zone may be a region in which the fluid flowing within the chamber 110 is decelerated and moves slowly. In the stagnation zone, a vortex may be formed to impede the flow of the fluid, causing the fluid to stagnate.

In addition, the light irradiation region A may correspond to a zone in which the direction of flow of the fluid changes. For example, as the fluid flowing within the chamber 110 hits the walls 112, 114, and 116 in the light irradiation region A and changes direction, a zone in which the flow velocity of the fluid is reduced and the fluid becomes stagnant may be formed. This zone may be set as the light irradiation region A.

The light irradiation region A may be spaced apart from the light sensor unit 130. In this way, it may be possible to prevent light emitted from the light source unit 120 from being directly delivered to the light sensor unit 130 while allowing light generated by suspended particles in the fluid, which are excited by light emitted from the light source unit 120, to be incident on the light sensor unit 130 through scattering or reflection, thereby improving reliability of the suspended organic matter detection apparatus 100.

Here, to further improve detection accuracy, a light absorbing layer including a light absorbing material may be disposed in one area of the light irradiation region A. The light absorbing layer may include a light absorbing material, such as carbon black, amorphous silicon (a-Si), copper oxide (CuO), iron oxide (Fe₃O₄), a transition metal chalcogenide (MoS₂, WS₂), an organic dye, or perovskite, to effectively absorb light delivered from the light source unit 120. The type of light absorbing material used may be varied depending on the wavelength of light received by the light sensor unit 130, the excitation wavelength of organic matter to be detected, and the purpose of analysis.

The chamber 110 may include an opening 110a or 110b for introducing or discharging the fluid into or from the internal space of the chamber. The opening may be an inlet for introduction of the fluid into the chamber, an outlet for discharge of the fluid from the chamber, or a combination thereof. The opening 110a or 110b may be formed in any of the walls 112, 114, and 116 of the chamber 110. The chamber 110 may include a plurality of openings 110a, 110b to ensure smooth introduction and discharge of the fluid.

The opening 110a or 110b may be formed in a wall on which the light irradiation region A is formed or may be formed in a wall different from the wall on which the light irradiation region A is formed.

Herein, the inner wall of the chamber 110 where the light irradiation region A is formed is referred to as a first wall 112. FIG. 1 illustrates an example in which the opening 110a or 110b is formed in a second wall 114 different from the first wall 112. When the opening 110a or 110b is formed in the second wall 114, rather than in the first wall 112 on which the light irradiation region A is formed, it may be possible to increase the residence time of the fluid in the light irradiation region A within the chamber 110, thereby enhancing the accuracy of detecting suspended organic matter. However, it should be understood that the present disclosure is not limited thereto and the opening 110a or 110b may be formed in the first wall 112. When the opening 110a or 110b is formed in the first wall 112, the opening 110a or 110b may be spaced apart from the light irradiation region A. In this way, it may be possible to prevent light emitted from the light source unit 120 from being directly delivered to the light sensor unit 130, thereby improving reliability of the suspended organic matter detection apparatus 100.

Specifically, the chamber 110 may include a first opening 110a formed in the second wall 114, which is opposite the first wall 112, to allow introduction and discharge of the fluid. In this way, it may be possible to ensure that the fluid introduced through the first opening 110a flows towards the light irradiation region A. The first opening 110a may be configured to allow introduction or discharge of the fluid into or from the chamber.

Alternatively or additionally, the chamber 110 may further include a second opening 110b, besides the first opening 110a. For example, the chamber 110 may include a second opening 110b formed in the second wall 114 at a distance from the first opening 110a to allow introduction and discharge of the fluid therethrough. In this way, it may be possible to increase the residence time of the fluid within the chamber 110, thereby improving the accuracy of detecting suspended organic matter.

However, it should be understood that the location of the second opening 110b is not limited thereto and the second opening 110b may be formed at various locations, considering a route through which the fluid flows within the chamber 110. For example, the second opening 110b may be formed in a sidewall different from the second wall 114. When the second opening 110b is formed in a sidewall different from the second wall 114, the first opening 110a and the second opening 110b may be disposed not to overlap each other in a vertical cross-section of the sidewall. In this way, it may be possible to increase the residence time of the fluid within the chamber 110, thereby improving the accuracy of detecting suspended organic matter.

In addition, when the second opening 110b is disposed to overlap the first opening 110a in a region parallel to the second wall section 114, the second opening 110b may have a different area than the first opening 110a to induce a vortex so as to increase the residence time of the fluid within the chamber. An increase in the residence time of the fluid within the chamber may ensure an enhancement in accuracy of detecting suspended organic matter.

The openings 110a, 110b may have various sizes. In addition, the first opening 110a and the second opening 110b may have different sizes from each other. When the first opening 110a and the second opening 110b have different sizes from each other, flow rates of the fluid through the first opening 110a and the second opening 110b may be adjusted to increase the amount of the fluid exposed to light in the light irradiation region A, thereby improving the accuracy of detecting suspended organic matter.

In FIG. 1, the arrow K indicates the tendency of the flow of the fluid. The fluid introduced through the first opening 110a may change direction after reaching the light irradiation region A to move towards the second opening 110b for discharge. In this way, it may be possible to decrease the flow velocity of the fluid in the light irradiation region A, thereby improving the accuracy of detecting suspended organic matter. However, this is merely one exemplary fluid flow tendency and the flow of the fluid is not limited to that indicated by the arrow K in FIG. 1. Conversely, it is also possible for air introduced through the second opening 110b to exit the chamber through the first opening 110a. As such, both the first opening 110a and the second opening 110b may function as both a fluid inlet and a fluid outlet.

The chamber 110 may be disposed in a flow path where fluid flow is created. For example, the chamber 110 may be disposed within a space where fluid flow is created by a fan of an air purifier, an air conditioner, or the like such that a natural pathway for introduction/discharge of the fluid into/from the chamber 110 through the openings 110a, 110b may be formed. In this way, it may be possible to detect suspended organic matter in the space where fluid flow is created.

The light source unit 120 serves to deliver light to the light irradiation region A and may be configured in various ways.

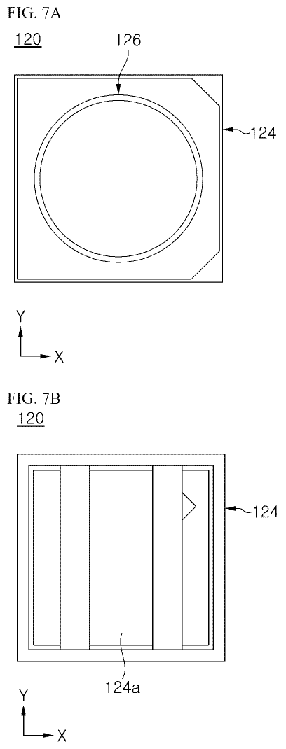

For example, referring to FIG. 7A to FIG. 7C, the light source unit 120 may include a light emitting device 122, a substrate 124 on which the light emitting device 122 is mounted, and a lens 126 disposed above the light emitting device 122.

The light emitting device 122 is a light emitting diode (LED) chip and may be a light source unit that generates light in a specific wavelength band capable of exciting suspended organic matter.

A wavelength range of light generated by the light emitting device 122 and emitted through the light source unit 120, including the peak wavelength and the full width at half maximum (FWHM) thereof, may include an absorption band of the suspended organic matter.

The light emitting device 122 may include a semiconductor layer. The semiconductor layer may include a first conductivity type semiconductor layer, a second conductivity type semiconductor layer, and an active layer disposed between the first conductivity type semiconductor layer and the second conductivity type semiconductor layer. The light emitting device 122 may further include a growth substrate on which the semiconductor layer is disposed. The semiconductor layer may grow on the growth substrate. The light emitting device 122 may include the plurality of the semiconductor layers. The plurality of the semiconductor layers may be spaced apart each other on the plane or may be stacked in a vertical direction.

The growth substrate may be a growth substrate for growing a gallium nitride semiconductor layer and may be, for example, a sapphire substrate, a silicon substrate, a SiC substrate, a spinel substrate, a Ga2O3 substrate, or the like. The growth substrate is not limited to a particular type and may be selected from any substrates so long as the substrate allows growth of nitride semiconductor layers thereon. The growth substrate may be removed after growth of the semiconductor layer.

The first conductivity type semiconductor layer may be a semiconductor layer grown on a surface of the growth substrate and may include a phosphide or nitride semiconductor, such as (Al, Ga, In) P or (Al, Ga, In) N. In addition, the first conductivity type semiconductor layer may be doped with at least one type of n-type dopant, such as Si, C, Ge, Sn, Te, Pb, or others. However, it should be understood that the disclosed technology is not limited thereto. Alternatively, the first conductivity type semiconductor layer may also be doped with a p-type dopant to become an opposite conductivity type. Furthermore, the first conductivity type semiconductor layer may include a single layer or multiple layers.

The active layer is a light emitting layer formed on a surface of the first conductivity type semiconductor layer, may include a phosphide or nitride semiconductor, such as (Al, Ga, In) P or (Al, Ga, In) N, and may be grown on the first conductivity type semiconductor layer through a technique, such as MOCVD, MBE, or HVPE. Further, the active layer may include a quantum well structure (QW) including at least two barrier layers and at least one well layer, and may further include a multi-quantum well structure (MQW) including a plurality of barrier layers and a plurality of well layers. The wavelength of light emitted from the active layer may be adjusted by controlling the composition ratio of materials constituting the well layers. In this case, the well layers may include the same element in common, for example, indium (In).

The second conductivity type semiconductor layer may be a semiconductor layer disposed on one side of the active layer. The second conductivity type semiconductor layer may include a phosphide or nitride semiconductor, such as (Al, Ga, In) P or (Al, Ga, In) N. The second conductivity type semiconductor layer may be doped to become a conductivity type opposite to the conductivity type of the first conductivity type semiconductor layer. For example, the second conductivity type semiconductor layer may be doped with p-type dopants, such as magnesium (Mg).

The light emitting device 122 may have a light emitting surface, through which light is emitted, on the first conductivity type semiconductor layer or the second conductivity type semiconductor layer. For example, light generated in the active layer may be emitted through the first conductivity type semiconductor layer or through the second conductivity type semiconductor layer. A surface of the first conductivity type semiconductor layer or a surface of the second conductivity type semiconductor layer may be formed with an uneven structure to improve light extraction efficiency.

For example, to detect organic carbon, a light emitting device 122 emitting light with a peak wavelength in the range of 200 nm to 400 nm may be used. In addition, to detect proteins such as bacteria, a light emitting device 122 emitting light with a peak wavelength in the range of 200 nm to 300 nm may be used as a light source. In addition, to detect organic carbon, a light emitting device 122 emitting light with a peak wavelength in the range of 280 nm to 450 nm may be used as a light source. In addition, to detect plant-based particles such as pollen, a light emitting device 122 emitting light with a peak wavelength in the range of 250 nm to 500 nm may be used as a light source. In addition, to detect complex particulate matter, light emitting devices 122 emitting light with different wavelengths may be disposed together. Here, given inherently lower luminous efficacy of short-wavelength light emitting devices 122, a light source emitting light with a wavelength of 350 nm to 450 nm may be used to enhance efficiency in detecting suspended organic matter relative to energy consumption.

Referring to FIG. 7A to FIG. 7C, the light source unit 120 may constitute a light emitting apparatus in which the light emitting device 122 is mounted on a substrate 124.

The substrate 124 is a lead frame electrically connected to negative and positive electrode pads of the light emitting device 122 and may include a heat dissipation pad 124a on a lower surface thereof.

The substrate 124 may be formed on an upper surface thereof with a concave cavity CV in which the light emitting device 122 is seated. A side surface of the cavity CV may be a reflective surface configured to reflect light from the light emitting device 122 upwards. The reflective surface may be sloped. To enhance luminous efficacy, a reflective material compositionally distinct from a material for the substrate 124 may be disposed on the reflective surface. The reflective material may include a metal, such as Au, Ag, and Al, or a metal oxide, such as alumina and titanium oxide. Here, the type of reflective material used may be selected depending on the wavelength of the light emitting device 122. For example, a reflective material having a reflectance of 60% or more at a wavelength of 350 nm to 450 nm may be used to enhance luminous efficacy. It should be understood that the cavity CV formed on the upper surface of the substrate 124 is not an essential component and may be omitted.

The lens 126 is an optical member disposed above the light emitting device 122 to control an optical path of light emitted from the light emitting device 122 and may be configured in various ways.

Light transmitted through the lens 126 may be emitted from the light source unit 120 with a specific beam angle to be directed towards the light irradiation region A. The lens 126 may be configured to adjust the beam angle of the light towards the light irradiation region A.

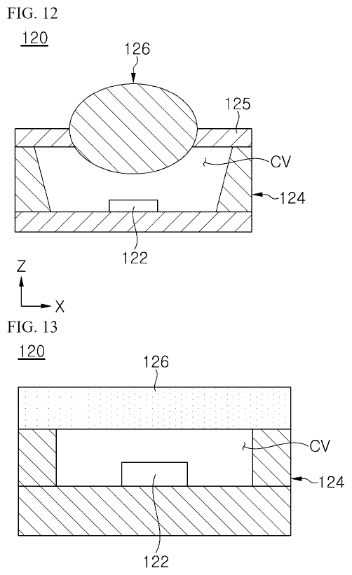

FIG. 7A to FIG. 13 illustrate various shapes for the lens 126. The lens 126 may include a hemispherical lens, a spherical ball lens, or a semi-elliptical lens, without being limited thereto. The lens 126 may be seated directly on the substrate 124 or may be mounted on a separate lens frame disposed at an upper side of the substrate 124.

When the lens 126 is a hemispherical lens, the lens 126 may be configured to have various curvatures depending on design, as shown in FIG. 7c and FIG. 8. The lens 126 may have the largest curvature in a region that vertically overlaps a region in which the light emitting device 122 is disposed. In addition, the lens 126 may have a larger curvature in a region vertically overlapping the upper surface of the light emitting device 122 than in other regions. In this way, it may be possible to achieve efficient adjustment of the beam angle.

With the light emitting device 122 and the lens 126, the light source unit 120 may be implemented to have a beam angle of 60° or less. More preferably, the light source unit 120 has a beam angle of 30° or less.

If the beam angle of the light source unit 120 exceeds 60°, optical noise may occur due to light spreading out at an angle of greater than 60°, necessitating appropriate management of such light.

FIG. 4 illustrates the intensity of light emitted from the light source unit 120 as a function of central angle with respect to an optical axis L. Optical noise may be minimized by minimizing a distance between two points on the intensity curve at which the intensity of light emitted from the light source unit 120 is half of a peak intensity thereof (that is, FWHM) and by appropriately managing light spreading out at an angle of greater than 60°.

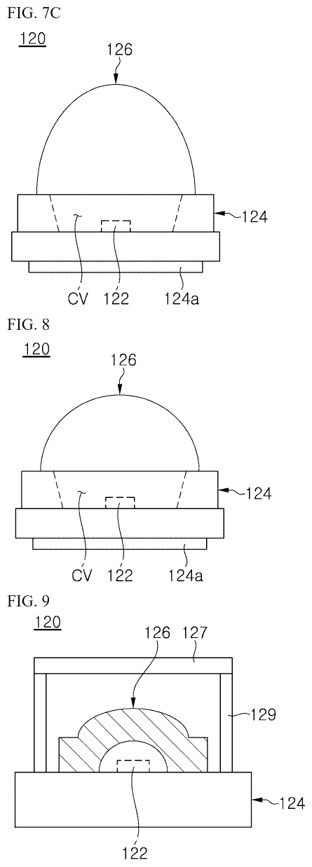

To this end, the light source unit 120 may further include a reflective sidewall 129 surrounding a side surface of the lens 126 and reflecting light transmitted through the lens 126, as shown in FIG. 9 to FIG. 11.

The reflective sidewall 129 may have a reflective surface reflecting light emitted laterally from the lens 126 to concentrate the light towards a central region. For example, the reflective sidewall 129 may be formed of a metal, such as Al, Ag, or Au, or an insulating material plated with a metal, to enhance reflection efficiency. However, it should be understood that the material for the reflective sidewall 129 is not limited thereto and, as another example, the reflective sidewall 129 may include highly reflective particles, such as TiO₂, BaSO₄, or FET.

The reflective sidewall 129 may have a reflectance of 60% or more at a peak wavelength of the light emitting device 122. In this way, it may be possible to enhance luminous efficacy.

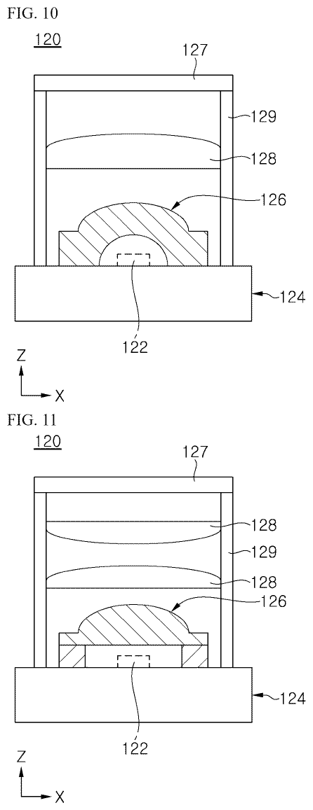

In addition, referring to FIG. 10 and FIG. 11, the light source unit 120 may further include at least one optical member 128 configured to concentrate light transmitted through the lens 126. The optical member 128 may be disposed on the reflective sidewall 129 described above.

The optical member 128 may have a curved region. The optical member 128 may vertically overlap the light emitting device 122. A region of the optical member 128 vertically overlapping the light emitting device 122 may have a different curvature than an outer region of the optical member 128. In addition, the lens 126 may have a greater curvature in a region vertically overlapping an upper surface of the optical member 128 than in other regions thereof. The optical member 128 may have a smaller curvature than the lens 126. In this way, it may be possible to achieve precise adjustment of the beam angle of light towards the light irradiation region.

In addition, referring to FIG. 9 to FIG. 11, the light source unit 120 may further include an optical filter 127 disposed above the lens 126 and transmitting light having a specific wavelength therethrough. The optical filter 127 may be seated on an upper surface of the reflective sidewall 129. The optical filter 127 may be a filter with high transmittance in a specific wavelength range. For example, the optical filter 127 may have a transmittance of 80% or more at a wavelength of 350 nm to 380 nm. The optical filter 127 may be a bandpass filter. To selectively transmit only a specific UV band, the optical filter may include a thin-film interference structure composed of alternating layers of a high-refractive index material, such as TiO₂, Ta₂O₅, or ZrO₂, and a low-refractive index material, such as SiO₂, MgF₂, or AlF₃. This multilayer structure may ensure high selectivity and wavelength precision in the UV region. In addition, the optical filter 127 may function as a protective member to protect the light emitting device 122 from external foreign matter.

The reflective sidewall 129, the optical filter 127, and the optical member 128 are optional components, rather than essential components, and may be configured in various combinations depending on embodiments.

The light source unit 120 may be disposed at various locations within the chamber 110. However, the light source unit 120 may be disposed at a location and angle that allows easy delivery of light to the light irradiation region A.

Referring again to FIG. 1, the light source unit 120 may be disposed on a wall 114 or 116 other than the first wall 112 on which the light irradiation region A is formed. For example, the light source unit 120 may be disposed on the third wall 116 adjacent to the first wall 112.

An optical axis L of light emitted from the light source unit 120 may be tilted at an acute angle with respect to the inner wall IS of the chamber 110 on which the light irradiation region A is formed. That is, the optical axis L of light emitted from the light source unit 120 and the first wall 112 may meet at an acute angle. That is, the optical axis L of light emitted from the light source unit 120 is disposed to avoid normal incidence of the light on the plane of the first wall 112.

For example, the optical axis L may be tilted at an angle of 10° to 20° with respect to the inner wall IS of the chamber 110 on which the light irradiation region A is formed. That is, the acute angle α formed by the optical axis L and the first wall 112 may be in the range of 10° to 20°. More preferably, the acute angle α formed by the optical axis L and the first wall 112 is 15°. In this way, it may be possible to increase the area over which suspended organic matter is irradiated with light, thereby enhancing efficiency in detecting the suspended organic matter.

Since the light irradiation region A is formed on the first wall 112 and the optical axis L is tilted at an angle of 15° with respect to the first wall 112, the area onto which light emitted from the light source unit 120 is projected may be formed to an appropriate size. With the optical axis L tilted with respect to the first wall 112, the light irradiation region A may have a larger area than the light emitting device 122 of the light source unit 120. The area of the light irradiation region A may be 10 to 15 times the area of the light emitting device 122. In this way, it may be possible to allow the fluid to be exposed to light over a wider area, thereby enhancing detection sensitivity.

In addition, since the light irradiation region A is formed on the first wall 112 and the light source unit 120 is disposed on the third wall 116 adjacent to the first wall 112, the optical axis L of light emitted from the light source unit 120 may be tilted at an angle β of 70° to 80° with respect to a sidewall of the chamber 110 (that is, the third wall 116) on which the light source unit 120 is disposed, provided that the first wall 112 is perpendicular to the third wall 116. More preferably, the optical axis L of light emitted from the light source unit 120 is tilted at an angle β of 65° to 85° with respect to the sidewall of the chamber (that is, the third wall 116) on which the light source unit 120 is disposed.

Light emitted from the light source unit 120 is incident on the fluid stagnating in the light irradiation region A, and suspended organic matter in the fluid absorbs the light and emits light with a different wavelength as excitation light. The light sensor unit 130 is configured to detect light within the chamber 110, specifically the excitation light emitted from the suspended organic matter. The light sensor unit 130 may have different light detection sensitivities at different wavelengths. Here, the light sensor unit 130 has a sensitivity of 50% or more in a peak wavelength region of the excitation light, thereby allowing easy detection of the excitation light.

When light emitted from the light source unit 120 has a wavelength of 350 nm to 450 nm, the excitation light is light with a longer wavelength than the emitted light and may have a wavelength of 450 nm to 700 nm. The excitation light may have multiple intensity peaks in the wavelength range of 450 nm to 700 nm.

To avoid noise caused by interference between light emitted from the light source unit 120 and the excitation light, a wavelength difference between the light emitted from the light source unit 120 and the excitation light may be set to 50 nm or more. A difference in peak wavelength between the light emitted from the light source unit 120 and the light detected by the light sensor unit 130 may be 50 nm or more.

The light emitting device 122 of the light source unit 120 may be composed of a plurality of layers with different compositions, wherein at least one of the plurality of layers may have a relatively high Al content. In addition, the light emitting device 122 may have a bandgap energy of, for example, 2.75 eV to 3.26 eV.

Although an example in which the light source unit 120 has a narrow beam angle has been described with reference to FIG. 1 and FIG. 4, it should be understood that the scope of the present disclosure is not limited thereto. Specifically, the light source unit 120 may have a wide beam angle of 120° or more. Here, the lens 126 may be formed in a flat plate shape in which both upper and lower surfaces thereof are flat, as shown in FIG. 13. When the light source unit 120 has a wide beam angle, light from the light source unit 120 may be evenly dispersed over a broad area, thereby ensuring an increased contact area between the light and the fluid inside the chamber 110 and thus enhanced efficiency in detecting suspended organic matter. Here, to further enhance detection accuracy, the chamber 110 may further include a reflector disposed therein to concentrate light onto a specific region.

The light sensor unit 130 may detect suspended organic matter in the fluid entering the internal space of the chamber 110. The light sensor unit 130 may include, for example, a light sensor configured to detect the excitation light and may further include a spectroscope configured to split the excitation light into component wavelengths.

The light sensor unit 130 may be disposed in various locations so long as the light sensor unit 130 can detect the excitation light. For example, the light sensor unit 130 may be disposed outside the chamber 110. Specifically, the light sensor unit 130 may be disposed outside the chamber 110 adjacent to the opening 110a or 110b.

The light sensor unit 130 may be disposed adjacent to the opening 110a or 110b of the chamber 110. When the chamber 110 has a plurality of openings 110a, 110b, the light sensor unit 130 is preferably disposed adjacent to an opening closer to the light irradiation region A than the other openings, that is, the first opening 110a in FIG. 1.

Since the light sensor unit 130 is disposed adjacent to the opening 110a or 110b, the light sensor unit 130 can detect the excitation light exiting the chamber 110 through the opening 110a or 110b.

The light sensor unit 130 may be composed of a plurality of layers with different compositions, wherein at least one of the plurality of layers may have a relatively high Ga or Cd content. In addition, the light sensor unit 130 may have a bandgap energy of, for example, 2.30 eV to 2.45 eV.

The light emitting device 122 and the light sensor unit 130 may have different bandgap energies, leading to a difference in temperature resistance therebetween, which may be advantageous for temperature management.

The light sensor unit 130 may further include a light blocking coating to block light from the light source unit 120. The light blocking coating may be disposed at a light incidence side of the light sensor unit 130. Alternatively, the light blocking coating may be disposed on an upper surface of the light sensor unit 130. The light blocking coating may have a transmittance of less than 30% in the peak wavelength range of light emitted from the light source unit 120. The light blocking coating may be a coating layer with a light transmittance of less than 30% at a wavelength of 350 nm to 400 nm.

The light blocking coating may transmit excitation light from suspended organic matter therethrough and may have a transmittance of 60% or more with respect to the excitation light. For example, the light blocking coating may have a transmittance of 60% or more at a wavelength of 450 nm to 700 nm.

The light blocking coating may include a multilayer thin-film structure designed to limit light transmittance to less than 30% in a UV band ranging from 350 nm to 400 nm and to maintain light transmittance at 60% or more in a visible band ranging from 450 nm to 700 nm. The thin-film structure may be formed by alternately stacking a high-refractive index material, such as TiO₂ or ZrO₂, and a low-refractive index material, such as SiO₂ or MgF₂, to induce interference effects at specific wavelengths, thereby achieving desired spectral characteristics.

Such a light blocking coating may also be provided to the light source unit 120 described above, wherein the light blocking coating provided to the light source unit 120 may have a different transmission spectrum than the light blocking coating provided to the light sensor unit 130. In this way, it may be possible to reduce spectral overlap between light emitted from the light emitting device and excitation light emitted from suspended organic matter, thereby enhancing the accuracy of detecting suspended organic matter.

The light sensor unit 130 may include an optical sensor. The optical sensor may be a passive device configured to output an electrical signal in response to input of light energy. The electrical signal may be a current signal. For example, the optical sensor is one of a phototransistor, a photoresistor, or a photodiode and may be a photosensitive device configured to read the excitation light.

Although FIG. 1 illustrates a case in which the optical axis L of light emitted from the light source unit 120 and the first wall 112 meet at an acute angle α, it should be understood that the present disclosure is not limited thereto and the optical axis L may be disposed at various angles with respect to the first wall 112, including parallel to the first wall 112.

The suspended organic matter detection apparatus 100 may further include a data processor (processing circuitry) configured to receive sensing values from the light sensor unit 130 and to calculate data including at least one of the type, presence, and quantity of suspended organic matter through signal processing.

The suspended organic matter detection apparatus 100 may further include a display unit configured to output the data calculated by the data processor visually or audibly.

In addition, the suspended organic matter detection apparatus 100 may further include a controller 190 configured to receive the data from the data processor and to control operation of the suspended organic matter detection apparatus based on the received data.

Furthermore, the suspended organic matter detection apparatus 100 according to the present disclosure may further include a light intensity sensor disposed adjacent to the light source unit 120 to detect the amount of light emitted from the light source unit 120.

The controller 190 may control the detection apparatus 100 to output an alarm, such as an audible warning or a visible warning, when a sensing value detected by the light intensity sensor drops to less than or equal to a predetermined reference value.

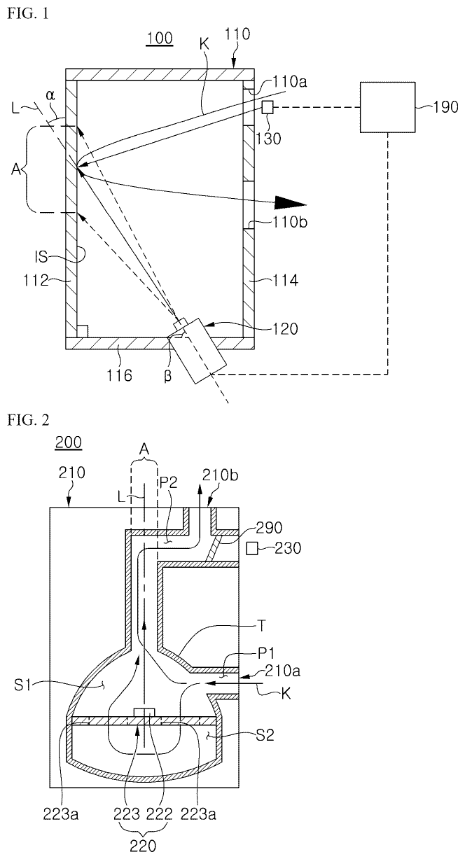

By way of another example, FIG. 2 illustrates a suspended organic matter detection apparatus 200 according to another embodiment of the present disclosure. Hereinafter, the suspended organic matter detection apparatus 200 of FIG. 2 will be described in detail, focusing on differences thereof from the suspended organic matter detection apparatus 100 of FIG. 1.

Referring to FIG. 2, the suspended organic matter detection apparatus 200 may include a chamber 210 formed therein with an inlet path P1, an outlet path P2, and an internal space S1, S2.

The inlet path P1 is a flow path through which a fluid is introduced into the chamber 210 and may communicate with a first opening 210a. The outlet path P2 is a flow path through which the fluid is discharged from the chamber 210 and may communicate with a second opening 210b. The first opening 210a and the second opening 210b may be located on different sidewalls of the chamber 210.

By way of example, referring to FIG. 2, the first opening 210a and the second opening 210b may be provided to different sidewalls of the chamber 210. An opening direction of the first opening 210a may be perpendicular to an opening direction of the second opening 210b. Here, a flow direction of the fluid at the first opening 210a may be perpendicular to a flow direction of the fluid at the second opening 210b. In this way, it may be possible to ensure increased vortex formation within the chamber 210, thereby increasing the residence time of the fluid within the chamber 210 and thus improving efficiency in detecting suspended organic matter.

In addition, the first opening 210a and the second opening 210b may be formed at different heights in a vertical direction. Through adjustment of the heights of the first opening 210a and the second opening 210b, the flow velocity of the fluid within the chamber 210 may be regulated to increase the residence time of the fluid within the chamber 210, thereby improving efficiency in detecting suspended organic matter.

The chamber 210 may further include a reflective layer T coated on an inner wall IS thereof.

The internal space S1, S2 may be a space between the inlet path P1 and the outflow path P2, in which the fluid flowing within the chamber resides. An inner wall of the chamber 210 defining the internal space S1, S2 may be formed with a curved surface. The curved surface may be formed along a route through which the fluid flows and may have different curvatures in deferent sections or regions of an air flow path. The curved surface of the inner wall of the chamber 210 may induce a vortex, thereby increasing the residence time of the fluid within the chamber 210.

In addition, the suspended organic matter detection apparatus 200 may include a light source unit 220 disposed in the chamber 210, wherein the light source unit 220 may include a light emitting device 222 and a base 223 supporting the light emitting device 222. The light emitting device 222 may be disposed inside the chamber 210 through the base 223.

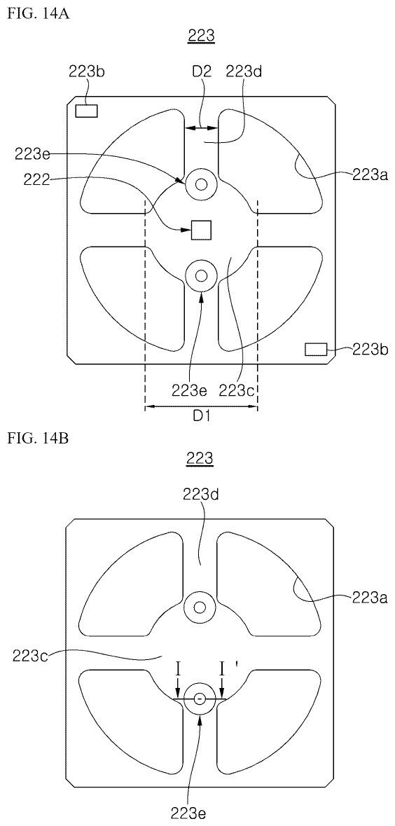

The light emitting device 222 may be mounted on one surface of the base 223. Referring to FIG. 14A and FIG. 14B, the base 223 may be a plate-shaped printed circuit board (PCB) and may be provided on one surface thereof with a power connector 223b connected to a power line for applying electric power to the light emitting device 222. FIG. 14A is top view of the base 223 and FIG. 14B is a bottom view of the base 223.

The base 223 may be formed in one region thereof with a seating region 223c in which the light emitting device 222 is seated and may be formed at an outer edge thereof with a wiring region in which the power connector 223b is disposed. At the power connector 223b in the wiring region, an electrical wire may be connected to a power source. The seating region 223c and the wiring region may be spaced apart from each other.

In addition, the base 223 includes a connection region 223d connecting the seating region 223c to the wiring region, wherein the connection region 223d may include a plurality of connection regions 223d arranged around a periphery of the seating region 223c. The plurality of connection regions 223d may extend radially outward from an edge of the seating region 223c in the form of a spoke to be connected to the wiring region. In this way, it may be possible to allow the wiring region to be spaced apart from the seating region 223c, thereby reducing light interference and mitigating noise.

The base 223 may be formed with a passage 223a vertically penetrating the base 223 and bordered by the connection region 223d, the wiring region, and the seating region 223c. The passage 223a permits passage of light and the fluid therethrough. That is, the passage 223a may also serve as a path through which light passes. The passage 223a may be formed in a movement path of the fluid or light. Although FIG. 14A and FIG. 14B show an embodiment in which the base 223 includes four passages 223a, it should be understood that the present disclosure is not limited thereto. The base 223 may include a plurality of passages 223a so as not to hinder efficient movement of the fluid or light.

A diameter D1 of the seating region 223c may be greater than a width D2 of the connection region 223d. Since the seating region 223c has a relatively large area, the seating region 223c may function as a heat dissipation part that dissipates heat generated from the light emitting device 222, thereby improving a reliability of the light emitting device 222. Here, the seating area 223c may have a smaller area than the passage 223a to reduce the influence thereof on the flow velocity of air.

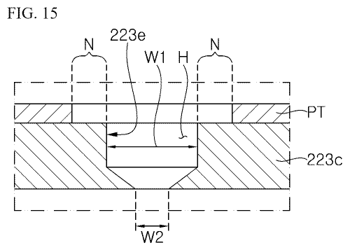

In addition, the base 223 may be formed in one region thereof with a fastening part 223e for mounting. FIG. 15 is a cross-sectional view of the fastening part 223e taken along line I-I′ of FIG. 14B. The base 223 may include a coating layer PT disposed in one region thereof. The coating layer PT may be disposed on the fastening part 223e. One region of the fastening part 223e may be an exposed region N in which the coating layer PT is omitted. For example, an exposed region N revealing an upper surface of the fastening part 223e may be formed by omitting the coating layer PT along a periphery of the fastening part 223c. By omitting the coating layer PT in specific regions, the height of the base 223 may be easily reduced.

A fastening screw or a shank may be mounted on the fastening part 223c, wherein a head of the screw or the shank may be partially fitted into the exposed region N. In this way, it may be possible to minimize the obstruction of the optical path of the light emitting device 222 by the fastening screw, thereby enhancing luminous efficacy. A depth of the exposed region N may be greater than a height of the coating layer PT. The depth of the exposed region N may be varied depending on the height of the head of the screw.

The fastening part 223e may be formed with a hole H vertically penetrating the base 223. The hole H may define a section with a varying width. For example, a width W1 of an upper end of the hole H may be greater than a width W2 of a lower end of the hole H. In addition, the hole H may define a section tapered from top to bottom. Accordingly, the hole H may have the smallest width W2 at the lower end thereof, thereby allowing the fastening screw to be stably mounted inside the hole H.

Although FIG. 14A and FIG. 14B illustrate a case in which the base includes two fastening parts 223e, it should be understood that the present disclosure is not limited thereto and the base may include various numbers of fastening parts.

The light source unit 220 may further include a light guide disposed on the base 223. The light guide may be disposed in one region of the base 223. The light guide may include a coating layer to reflect light emitted from the light emitting device 222, thereby enhancing the luminous efficacy and ensuring light concentration. The coating layer may be an Al coating, a TiO₂ coating, or a multi-dielectric coating. Alternatively, the coating layer may be a non-metallic reflective layer, such as PTFE, PET, or a multilayer polymeric reflective film, and may be provided in film form. Use of the light guide allows the light emitting device 222 to be spaced apart from the base 223, thereby enhancing heat dissipation efficiency.

The light guide and the light emitting device 222 may be disposed on opposite surfaces of the base 223. For example, when the light emitting device 222 is disposed on an upper surface of the base 223, the light guide may be disposed on a lower surface of the base 223. The light emitting device 222 and the light guide may overlap each other in a vertical direction of the base 223.

Referring to FIG. 2, the base 223 may be disposed to traverse the internal space S1, S2 to divide the internal space S1, S2 into a first internal space S1 and a second internal space S2 with respect to the base 223. That is, the internal space of the chamber 210 may be partitioned into the first internal space S1 and the second internal space S2 by the base.

Here, the first internal space S1 is an upper space with respect to the base 223 and may be directly connected to the first opening 210a and the second opening 210b.

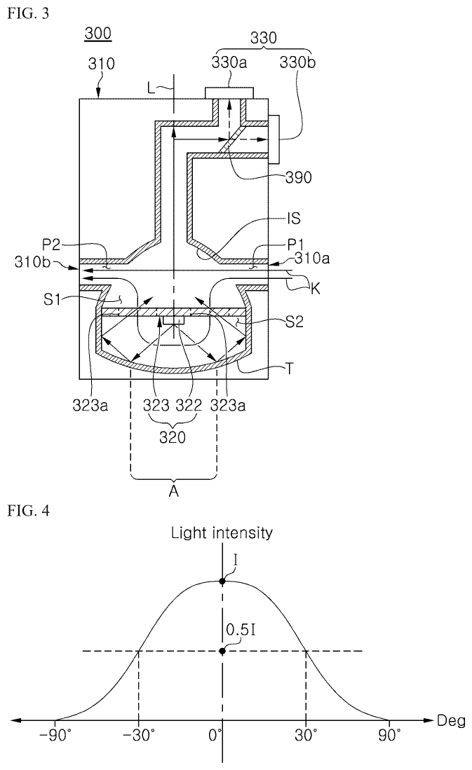

Referring to FIG. 2, the light emitting device 222 may be disposed on the upper surface of the base 223 to face the first internal space S1. In this way, it may be possible to reduce design complexity. However, it should be understood that the present disclosure is not limited thereto and, referring to FIG. 3, the light emitting device 222 may be disposed on the lower surface of the base 223 to face the second internal space S2. In this way, it may be possible to prevent light from directly reaching the light sensor unit, thereby reducing noise and improving detection accuracy.

In FIG. 2, a route of the fluid introduced through the opening 210a or 210b is indicated by the arrow K. Referring to FIG. 2, the fluid introduced through the first opening 210a may enter the first internal space S1 and then flow towards the second opening 210b through the outlet path P2. Alternatively, after entering the first internal space S1, the fluid may pass through the passage 223a of the base 223 into the second internal space S2, flow back to the first internal space S1 through the passage 223a, and flow towards the second opening 210b through the outlet path P2.

That is, with the internal space S1, S2 partitioned into the first internal space S1 and the second internal space S2 and the base 223 formed with the passage 223a, the suspended organic matter detection apparatus 200 may have a structure that allows the fluid to stay within the chamber for a prolonged period of time while circulating through the internal spaces S1, S2 due to a vortex formed therein, thereby increasing the residence time of the fluid within the chamber and thus improving efficiency in detecting suspended organic matter.

Furthermore, an inner wall (upper wall) of the first internal space S1 within the chamber 110 that faces the upper surface of the base 223 may include a curved surface. Similarly, an inner wall (lower wall) of the second internal space S2 within the chamber 110 that faces the lower surface of the base 223 may include a curved surface. Each of the upper wall and the lower wall may have different curvatures in different regions.

In addition, the curved surface of the upper wall may have a different curvature than the curved surface of the lower wall. For example, the curved surface of the upper wall may have a greater curvature than the curved surface of the lower wall. A central region of the upper wall may communicate with the outlet path P2.

For example, one region of the first internal space S1 may have a greater curvature than one region of the second internal space S2. In the first internal space S1, which has a larger curvature, the fluid flows relatively slowly, while, in the second internal space S2, which has a smaller curvature, the flow velocity of the fluid is faster than in the first internal space S1. This difference in flow velocity of the fluid may induce a vortex. This structure may increase the residence time of the fluid within the chamber, thereby improving efficiency in detecting suspended organic matter.

Alternatively, one region of the first internal space S1 may have a smaller curvature than one region of the first internal space S1 to allow the flow velocity of the fluid to be slower in the second internal space S2 than in the first internal space S1, thereby inducing a vortex.

In addition, referring to FIG. 2, the suspended organic matter detection apparatus 200 may further include a third opening, besides the openings 210a, 210b forming the inlet path or the outlet path. Here, the light sensor unit 230 may be disposed at the third opening side to detect excitation light exiting the chamber through the third opening. Here, a blocking member 290 may be disposed between the outlet path P2 and the second opening. The blocking member 290 serves to redirect the flow of the fluid towards the outlet path P2.

Here, the blocking member 290 may be a light transmissive member that transmits excitation light generated by suspended organic matter therethrough. The blocking member 290 may further have a filtering function to block a wavelength band corresponding to light emitted from the light source unit 220.

That is, the blocking member 290 may be an optical filter configured to partially reflect light within the chamber 210 while partially transmitting the light depending on wavelength. The optical filter may be a filter with high transmittance in a specific wavelength range. For example, the optical filter may have a transmittance of 80% or more at a wavelength of 350 nm to 380 nm. The optical filter may be a bandpass filter. To selectively transmit only a specific UV band, the optical filter may include a thin-film interference structure composed of alternating layers of a high-refractive index material, such as TiO₂, Ta₂O₅, or ZrO₂, and a low-refractive index material, such as SiO₂, MgF₂, or AlF₃. This multilayer structure may ensure high selectivity and wavelength precision in the UV region.

In addition, the blocking member 290 may also be configured as an optical member for light refraction.

By way of another example, FIG. 3 illustrates a suspended organic matter detection apparatus 300 according to a further embodiment of the present disclosure. Hereafter, the suspended organic matter detection apparatus 300 of FIG. 3 will be described in detail, focusing on differences thereof from the suspended organic matter detection apparatus 200 of FIG. 2.

In the suspended organic matter detection apparatus 300, an internal space of a chamber 310 is partitioned into a first internal space S1 and a second internal space S2 by a base 323, and the base 323 may be formed with a passage 323a to allow communication between the first internal space S1 and the second internal space S2.

Referring to FIG. 3, a first opening 310a and a second opening 310b may communicate with the first internal space S1. Here, the suspended organic matter detection apparatus 300 differs from the particulate matter detection apparatus 200 of FIG. 2 in that the second opening 310b is connected to a lateral side of the first internal space S1, rather than to an upper side of the first internal space S1. A fluid introduced through the first opening 310a may circulate within the first internal space S1 or may flow towards the second opening 310b after passing through the second internal space S2, instead of flowing towards a region above the first internal space S1. For example, the first opening 310a and the second opening 310b may be formed on opposite sidewalls of the chamber 310.

A light source unit 320 may be disposed on one surface of the base 323 that faces the second internal space S2. Light emitted from the light source unit 320 may be directed onto and reflected from a sidewall of the chamber 310 in the second internal space S2 and may enter the first internal space S1 through the passage 323a of the base 323.

That is, within the chamber 310, a light irradiation region A may be formed at the second internal space S2 side. Light delivered to the light irradiation region A in the second internal space S2 may be reflected towards the first internal space S1. Here, at least one of the first internal space S1 or the second internal space S2 may include a curved surface. The curved surface allows an angle formed by a region of the light irradiation region and the inner wall IS of the chamber 310 to be twisted by a curvature of the curved surface. In this way, it may be possible to increase the area of the light irradiation region A and to enhance excitation efficiency.

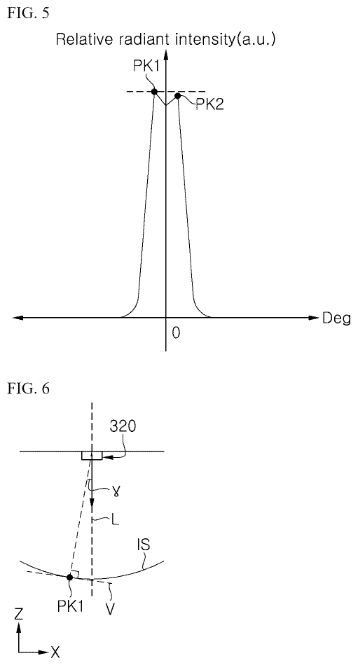

Referring to FIG. 5, an emission pattern of light emitted from the light source unit 320 may have a first peak PK1 and a second peak PK2. In FIG. 5, the point at which Deg is 0 corresponds to an optical axis L of the light source unit 320. A relative radiant intensity (a.u.) as a function of angle from the optical axis L may have two peaks PK1, PK2 at points deviating from the optical axis L. That is, in the emission pattern of the light source unit 320, the relative radiant intensity (a.u.) as a function of beam angle may have a first peak PK1 and a second peak PK2 at angle points deviating from 0°, which is a point perpendicular to a light emitting device 322. The first peak PK1 or the second peak PK2 may be located at a point tilted at an angle of −30° to −10° or +10° to +30° with respect to 0°.

Consequently, referring to FIG. 6, at a point at which the first peak PK1 meets the inner wall IS of the second internal space S2, the sidewall may be tilted at a specific angle γ with respect to the plane (horizontal plane) in which the light source unit 320 is located. The angle γ may be in the range of 10° to 30°. In this way, it may be possible to increase the area of the light irradiation region A and to enhance excitation efficiency.

Although FIG. 6 illustrates only the first peak PK1, at a point at which the second peak PK2 meets the sidewall of the second internal space S2, the sidewall may also be tilted at a specific angle γ with respect to the plane (horizontal plane) in which the light source unit 320 is located. However, the tilting angle of the sidewall at the point at which the first peak PK1 meets the sidewall of the second internal space may be different from the tilting angle of the sidewall at the point at which the second peak PK2 meets the sidewall of the second internal space. Here, in the emission pattern of the light emitting device 322, the angle formed between the first peak PK1 or the second peak PK2 and the inner wall IS may be an acute angle. In addition, at the point at which the first peak PK1 or the second peak PK2 meets the inner wall IS, the angle formed between the tangent V to the inner wall IS and a vertical axis L of the light emitting device 322 may be in the range of 70° to 80°. In this way, it may be possible to increase the area of the light irradiation region A in the second internal space S2 and to enhance excitation efficiency.

A light sensor unit 330 may be disposed at the first internal space S1 side to detect reflected light directed from the second internal space S2 towards the first internal space S1.

Here, the suspended organic matter detection apparatus 300 may further include an optical filter 390 configured to partially reflect light within the chamber 310 while partially transmitting the light depending on wavelength. The optical filter 390 may be a filter with high transmittance in a specific wavelength range. For example, the optical filter 390 may have a transmittance of 80% or more at a wavelength of 350 nm to 380 nm. The optical filter 390 may be a bandpass filter. To selectively transmit only a specific UV band, the optical filter may include a thin-film interference structure composed of alternating layers of a high-refractive index material, such as TiO₂, Ta₂O₅, or ZrO₂, and a low-refractive index material, such as SiO₂, MgF₂, or AlF₃. This multilayer structure may ensure high selectivity and high wavelength precision in the UV region.

For example, the optical filter 390 may be a dichroic mirror.

The optical filter 390 may be disposed obliquely with respect to an optical path of light to partially reflect the light towards an upper region of the chamber 310 while transmitting the light therethrough. An optical path of the reflected light may form an angle of 90° with an optical path of the transmitted light.

The light sensor unit 330 may include a first optical sensor 330a detecting light reflected from the optical filter 390 and a second optical sensor 330b detecting light transmitted through the optical filter 390.

The first optical sensor 330a is configured to detect excitation light reflected from the optical filter 390 and may be disposed at a location corresponding to the second opening 210b side in the suspended organic matter detection apparatus 200 of FIG. 2. However, for the suspended organic matter detection apparatus 300 of FIG. 3, a region where the first optical sensor 330a is disposed is not a region where the fluid exits the chamber, but a region where the reflected light is directed. Instead, the fluid inside the chamber 310 exits through a separate second opening 310b, which communicates with the first internal space S1.

The second optical sensor 330b is configured to detect excitation light transmitted through the optical filter 390 and may be configured in various ways.

By integrating the data acquired from both the first optical sensor 330a and the second optical sensor 330b, suspended organic matter can be detected. In this way, it may be possible to further enhance detection accuracy.

Although some embodiments have been described herein, it should be understood that these embodiments are provided for illustration only and are not to be construed in any way as limiting the present disclosure, and that various modifications, changes, alterations, and equivalent embodiments can be made by those skilled in the art without departing from the spirit and scope of the invention.

Therefore, the scope of the present disclosure should be defined by the appended claims and equivalents thereto, rather than by the detailed description given herein.

The following exemplary describe various devices, arrangements, and methods for manufacturing, processing, and operating. These items illustrate exemplary embodiments of the disclosed principles and concepts. It is to be understood that the disclosed features may be combined in any technically feasible manner, and the scope of such combinations is not limited to the specific examples set forth below.

Further exemplary embodiments are described in the following paragraphs.

Example 1: In accordance with one embodiment of the present disclosure, a suspended matter detection apparatus for detecting suspended matter in a fluid includes: a chamber defining a flow path of the fluid and including a light irradiation region on an inner wall thereof; a light source unit configured to deliver light to the light irradiation region; and a light sensor unit configured to detect light within the chamber, wherein the chamber includes an opening for introducing or discharging the fluid into or from an internal space of the chamber.

An optical axis of light emitted from the light source unit may be tilted at an angle of 10° to 20° with respect to the inner wall of the chamber on which the light irradiation region is formed.

The light irradiation region may be formed on a first wall of the chamber and the light source unit may be disposed on a third wall different from the first wall.

A second wall of the chamber may be adjacent to the third wall.

The optical axis of light emitted from the light source unit may be tilted at an acute angle with respect to the first wall.

The optical axis of light emitted from the light source unit may be tilted at an angle of 70° to 80° with respect to the third wall.

The light source unit may include a light emitting device and the light irradiation region may have a larger area than the light emitting device.

The suspended matter detection apparatus may further include a light sensor unit.

The light sensor unit may be disposed outside the chamber.

The light sensor unit may be disposed in a region adjacent to the opening.

The light sensor unit may have a bandgap energy of 2.30 eV to 2.45 eV.

The light sensor unit may further include a light blocking coating.

The light blocking coating may be disposed on an upper surface of the light sensor unit.

The light blocking coating may have a transmittance of less than 30% in a peak wavelength range of light from the light source unit.

The opening may include a first opening and a second opening, wherein the first opening and the second opening may be disposed on the same wall.

The suspended matter detection apparatus may further include a reflective layer.

The light source unit may include a lens configured to adjust a beam angle of light emitted towards the light irradiation region.

Example 2: In accordance with another embodiment of the present disclosure, a suspended matter detection apparatus for detecting suspended matter in a fluid, includes: a chamber defining a flow path of the fluid and including a light irradiation region on an inner wall thereof; a light source unit including a light emitting device configured to deliver light to the light irradiation region and a base supporting the light emitting device; and a light sensor unit configured to detect light within the chamber, wherein the chamber includes an opening for introducing or discharging the fluid into or from an internal space of the chamber, the base traverses the internal space of the chamber, the chamber is partitioned into a first internal space and a second internal space with respect to the base, and the light emitting device is disposed to face the first internal space.

The opening may include a first opening and a second opening, wherein an opening direction of the first opening may be perpendicular to an opening direction of the second opening.

The suspended matter detection apparatus may further include a reflective layer.

The light emitting device of the light source unit may be disposed on the base.

The base may be formed in one region thereof with a seating region where the light emitting device is seated and a wiring region in which a wire is connected to a power source, wherein the seating region and the wiring region may be spaced apart from each other.

A diameter of the seating region of the base may be greater than a width of a connection region connecting the seating region to the wiring region.

The base may be formed with a passage vertically penetrating the base.

The seating region of the base may have a smaller area than the passage.

The base may be formed in one region thereof with a fastening part.

A coating layer may be disposed on the fastening part.

One region of the fastening part may be an exposed region in which the coating layer is omitted.

The fastening part may be formed with a hole vertically penetrating the base.

A light guide may be disposed in one region of the base.

The light guide and the light emitting device may be disposed on opposite surfaces of the base.

The light source unit may include a lens configured to adjust a beam angle of light emitted towards the light irradiation region.

Example 3: In accordance with a further embodiment of the present disclosure, a suspended matter detection apparatus for detecting suspended matter in a fluid, includes: a chamber defining a flow path of the fluid and including a light irradiation region on an inner wall thereof; a light source unit including a light emitting device configured to deliver light to the light irradiation region and a base supporting the light emitting device; and a light sensor unit configured to detect light within the chamber, wherein the chamber includes an opening for introducing or discharging the fluid into or from an internal space of the chamber, the base traverses the internal space of the chamber, the chamber is partitioned into a first internal space and a second internal space with respect to the base, and the light emitting device is disposed to face the second internal space.

An inner wall of at least one of the first internal space or the second internal space may include a curved surface.

In an emission pattern of the light emitting device, a relative radiant intensity as a function of beam angle may have a first peak and a second peak at angle points deviating from 0°, which is a point perpendicular to the light emitting device.

The first peak or the second peak may be located at a point tilted at an angle of −30° to −10° or +10° to +30° with respect to 0°.

An angle formed by a tangent to the inner wall IS and a vertical axis of the light emitting device at a point at which the first peak or the second peak meets the inner wall IS may range from 70° to 80°.

The suspended matter detection apparatus may further include a reflective layer.

The light emitting device of the light source unit may be disposed on the base.

The base may be formed in one region thereof with a seating region in which the light emitting device is seated and a wiring region in which a wire is connected to a power source, wherein the seating region and the wiring region may be spaced apart from each other.

A diameter of the seating region of the base may be greater than a width of a connection region connecting the seating region to the wiring region.

The base may be formed with a passage vertically penetrating the base.

The seating region of the base may have a smaller area than the passage.

The base may be formed in one region thereof with a fastening part.

A coating layer may be disposed on the fastening part.

One region of the fastening part may be an exposed region in which the coating layer is omitted.

The fastening part may be formed with a hole vertically penetrating the base.

A light guide may be disposed in one region of the base.

The light guide and the light emitting device may be disposed on opposite surfaces of the base.

The light source unit may include a lens configured to adjust a beam angle of light emitted towards the light irradiation region.

<List of Reference Numerals>

| | |
|---|---|
| 100, 200, 300: Suspended organic matter detection apparatus | |
| 110, 210, 310: Housing | |
| 110a, 210a, 310a: First opening | |
| 110b, 210b, 310b: Second opening | |
| 112: First wall | 114: Second wall |
| 116: Third wall | |
| 120, 220, 320: Light source unit | |
| 122, 222, 322: Light emitting device | 124: Substrate |
| 126: Lens | |
| 127: Optical filter | 128: Optical member |
| 190: Controller | 129: Reflective Sidewall |
| 130, 230, 330: Light sensor unit | |
| 223, 323: Base | |
| 223a, 323a: Passage | 223b: Power connector |
| 223c: Seating region | 223d: Connection region |
| 223e: Fastening part | |

1. A suspended organic matter detection apparatus, comprising:
a chamber configured to define a flow path of a fluid and including a light irradiation region on an inner wall thereof;
a light source including a first semiconductor layer, a second semiconductor layer and an active layer disposed between the first semiconductor layer and the second semiconductor layer, and configured to deliver light to the light irradiation region; and
a light sensor configured to detect light within the chamber,
wherein the chamber includes an opening for introducing or discharging the fluid into or from an internal space of the chamber, and
wherein the light sensor is configured to detect suspended organic matter in the fluid entering the internal space of the chamber.

2. The suspended organic matter detection apparatus according to claim 1, wherein an optical axis of the light emitted from the light source is tilted at an acute angle with respect to the inner wall of the chamber on which the light irradiation region is formed.

3. The suspended organic matter detection apparatus according to claim 2, wherein the optical axis is tilted at an angle of 10° to 20° with respect to the inner wall of the chamber on which the light irradiation region is formed.

4. The suspended organic matter detection apparatus according to claim 1, wherein the light emitted from the light source has a peak wavelength of 350 nm to 400 nm.

5. The suspended organic matter detection apparatus according to claim 1, wherein the light sensor detects excitation light from the suspended organic matter.

6. The suspended organic matter detection apparatus according to claim 1, wherein the light source has a beam angle of 60° or less.

7. The suspended organic matter detection apparatus according to claim 1, wherein the light sensor is disposed adjacent to the opening.

8. The suspended organic matter detection apparatus according to claim 1, wherein the light source comprises a light emitting device and a base supporting the light emitting device.

9. The suspended organic matter detection apparatus according to claim 8, wherein the light source further includes a lens disposed above the light emitting device.

10. The suspended organic matter detection apparatus according to claim 8, wherein
the light source further includes a substrate forming a concave cavity in which the light emitting device is seated, and
a side surface of the cavity is an inclined reflective surface.

11. The suspended organic matter detection apparatus according to claim 9, wherein the light source further includes a reflective sidewall surrounding a side surface of the lens and reflecting light transmitted through the lens.

12. The suspended organic matter detection apparatus according to claim 9, wherein the light source further comprises at least one optical member configured to concentrate light transmitted through the lens.

13. The suspended organic matter detection apparatus according to claim 9, wherein the light source further includes an optical filter disposed above the lens to transmit light of a specific wavelength therethrough.

14. The suspended organic matter detection apparatus according to claim 8, wherein
the internal space of the chamber is partitioned into a first internal space and a second internal space by the base, and
the base is formed with a passage to allow communication between the first internal space and the second internal space.

15. The suspended organic matter detection apparatus according to claim 14, wherein
the light source is disposed on one surface of the base facing the second internal space, and
the opening communicates with the first internal space.

16. The suspended organic matter detection apparatus according to claim 15, wherein
the chamber further includes a reflective layer coated on the inner wall thereof, and
the light sensor is disposed at the first internal space side to detect reflected light directed from the second internal space to the first internal space.

17. The suspended organic matter detection apparatus according to claim 1, further comprising:
an optical filter configured to partially reflect light within the chamber while partially transmitting the light,
wherein the light sensor includes a first optical sensor configured to detect light reflected from the optical filter and a second optical sensor configured to detect light transmitted through the optical filter.

18. The suspended organic matter detection apparatus according to claim 1, wherein an emission pattern of light emitted from the light source has a first peak and a second peak.

19. A suspended organic matter detection apparatus, comprising:
a chamber configured to define a flow path of a fluid and including a light irradiation region on an inner wall thereof;
a light source including a first semiconductor layer, a second semiconductor layer, and an active layer disposed between the first semiconductor layer and the second semiconductor layer, and configured to deliver light to the light irradiation region; and
a light sensor configured to detect light within the chamber,
wherein the light source has a beam angle of 60° or less, and
wherein the light sensor is configured to detect suspended organic matter in the fluid entering the internal space of the chamber.

20. A suspended organic matter detection apparatus, comprising:
a chamber configured to define a flow path of a fluid and including a light irradiation region on an inner wall thereof;
a light source including a first semiconductor layer, a second semiconductor layer, and an active layer disposed between the first semiconductor layer and the second semiconductor layer, and configured to deliver light to the light irradiation region; and
a light sensor configured to detect light within the chamber,
wherein a difference in peak wavelength between the light emitted from the light source and the light detected by the light sensor is 50 nm or more, and
wherein the light sensor is configured to detect suspended organic matter in the fluid entering the internal space of the chamber.
